(19) United States
(12) Patent Application Publication
(10) Pub. No.: US 2009/0218167 A1
(43) Pub. Date: Sep. 3, 2009

(54) Executive escape system from high rise and process for making same

(76) Inventor: Eui Whee Lee, Newport, RI (US)

Correspondence Address: Eui W. Lee, 99 Coggeshall Avenue, Newport, RI, 02840, US

(21) Appl. No.: 12/380,243

(22) Filed: Feb. 25, 2009

Related U.S. Application Data
(60) Provisional application No. 61/067,310, filed on Feb. 28, 2008.

(51) Int. Cl. A62B 1/02; A62B 1/06; B66B 9/00

(52) U.S. Cl. 182/142

(57) ABSTRACT

The present invention relates to an escape system from a high rise building. More specifically, but without limitation, the present invention relates to a process for developing a concept, design, and manufacturing method for the high rise escape system. The escape system offers high rise dwellers the ability to escape from emergencies caused by fire or other unexpected accidents that result in disabled elevators and blocked stairways. It also provides peace of mind for the persons whose office or residence is 50-100 stories above the ground. According to emporium.com, the world's 100 largest cities have more than 70,000 high rise (12 stories or higher) buildings. This furniture-like device, when it is needed, allows up to 2 persons to escape from a high rise. The system breaks window glass and allows the aluminum cage component containing the escapees to descend to the ground safely.

### REFERENCES CITED [REFERENCED BY]U.S PATENT DOCUMENT

| | |
|---|---|
| Current U.S. Class: | 182/231; 182/211; 182/141; 182/14 |
| Current International Class: | A62B 1/00; A62B 1/02; A62B 1/06; |
| | A62B 3/00 |
| Field of Research: | 182/14, 141, 211, 231 |

| | | |
|---|---|---|
| 4,951,779 | August 1990 | Tseng |
| 6,050,365 | April 2000 | Newlin |
| 4,919,228 | April 1990 | Stefan |
| 4,865,155 | September 1989 | Montaigne |
| 4,660,678 | April 1987 | Krag |
| 7,055,653 | June 2006 | Hamada |
| 6,450,293 | September 2002 | Wu |
| 4,640,384 | February 1987 | Kucher, et al. |
| 4,440,267 | April 1984 | El-Sheika |
| 6,789,647 | September 2004 | Yeh |

### FIELD OF THE INVENTION

The invention relates to a process for developing a concept, design, and manufacturing method for a high rise escape system.

### BACKGROUND OF THE INVENTION

The number of high rises in the world is increasing at a rapid rate and the height of new buildings continues to break records. This increase is especially prominent in parts of Asia and the Middle East. This system represents a simple and reliable escape method from high rises when all descending equipment and other means of descent are unavailable due to unexpected accidents. An advantage of this system is its extreme simplicity. This system has no complicated computer controls and requires no complex handling. Another advantage of this system is its extreme reliability. Extreme reliability is made possible because no part is subjected to fatigue loading. The system's design is based on static strength. All the critical parts are designed with a minimum of 50% margin of safety. The design driver of this system is long term durability and reliability. Corrosion resistant durable materials such as stainless steel and aluminum are being used for the majority of its critical parts. Therefore, even if the system has not been operated for 10-20 years, the system should function reliably for its critical use.

### SUMMARY OF THE INVENTION

The invention relates to a process for developing a concept, design, and manufacturing method for a high rise escape system. This system is compact and stylish, resembling high end furniture when it is not in use. When in use, the system activates the telescopic ball screw actuator, glass breaker, and winch for aluminum cage to descend. This system uses electrical motors to power the telescopic ball screw actuator, winch, and telescopic ball screw actuator rotating device. These motors are backed by an uninterrupted power supply (UPS). The escape system is based on a simple mechanical process, not a computer controlled process. Pressing the first button swings the telescopic ball screw actuator; pressing the second button breaks the glass and extends the telescopic ball screw actuator and escapees in the aluminum cage; and pressing the third button lowers the aluminum cage to the ground. The variable speed winch lowers the aluminum cage and two rotary variable differential transformer (RVDT) position sensors control the winch speed.

### DESCRIPTION OF THE DRAWINGS

FIG. 1 Drawing shows the escape system in an inactivated condition.

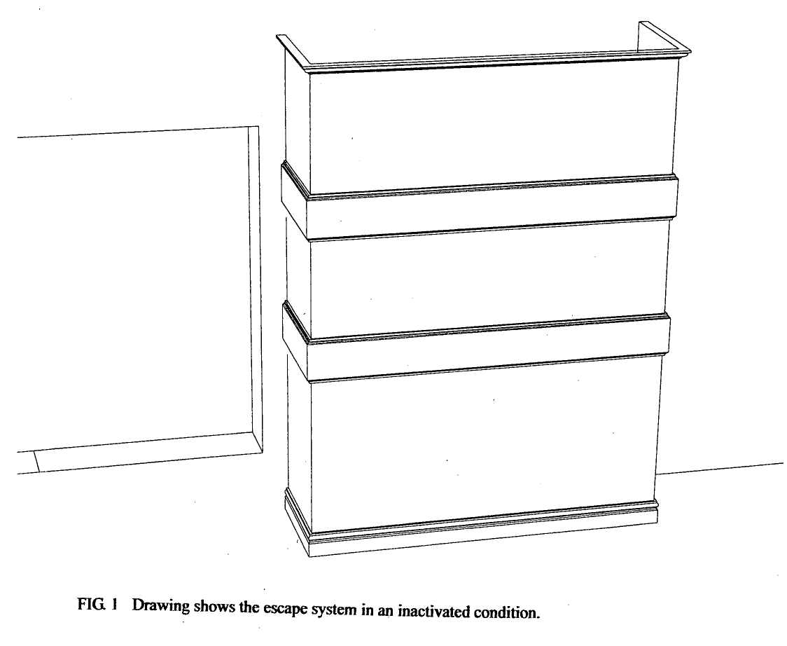

FIG. 2 Drawing shows the inside view of escape system.

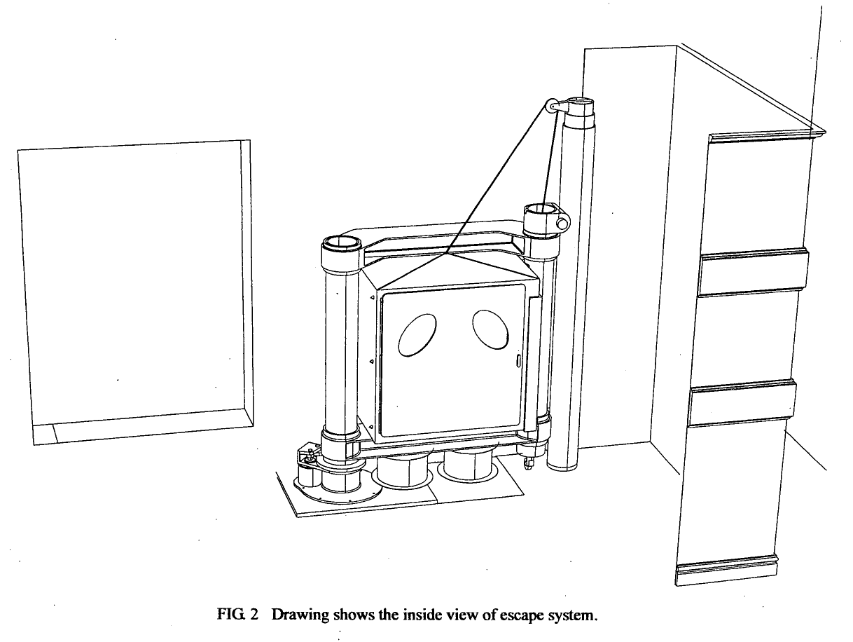

FIG. 3 Drawing shows the telescopic ball screw actuator rotating device starting to rotate.

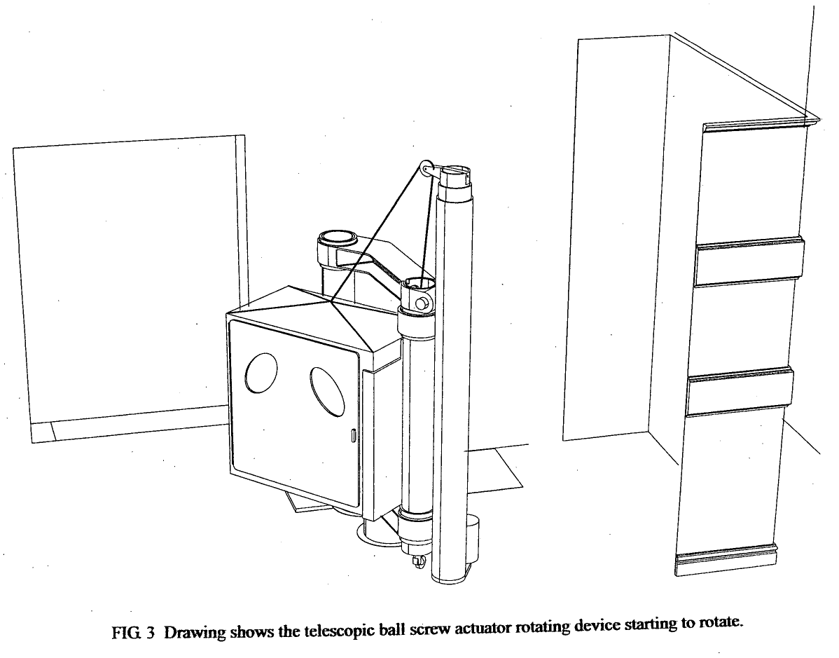

FIG. 4 Rotating device stops to rotate and escapees get into the aluminum cage.

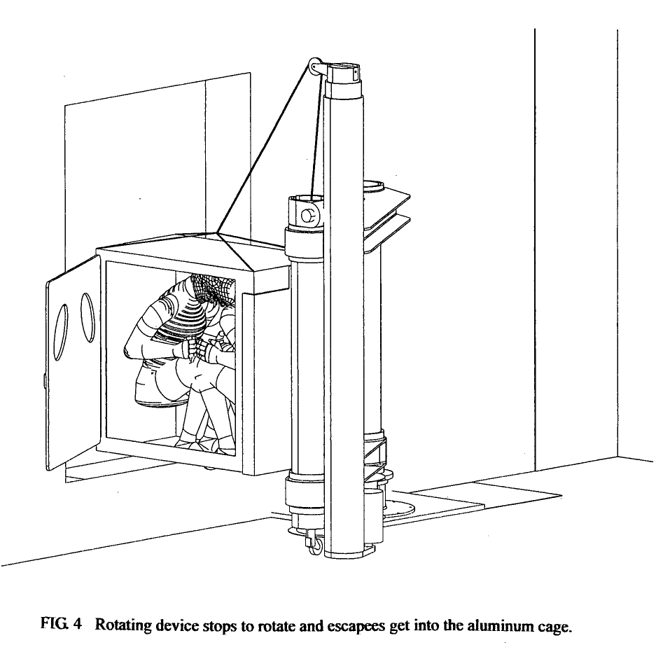

FIG. 5 Glass breaker broke the glass and the telescopic ball screw actuator starts to rotate to take horizontal position.

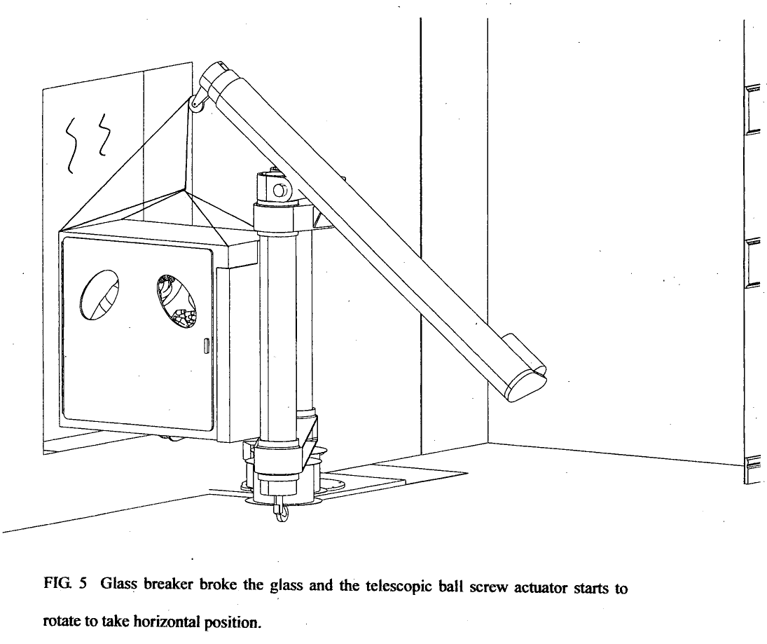

FIG. 6 Telescopic ball screw actuator resumes horizontal position and ready to carry the aluminum cage outside the window.

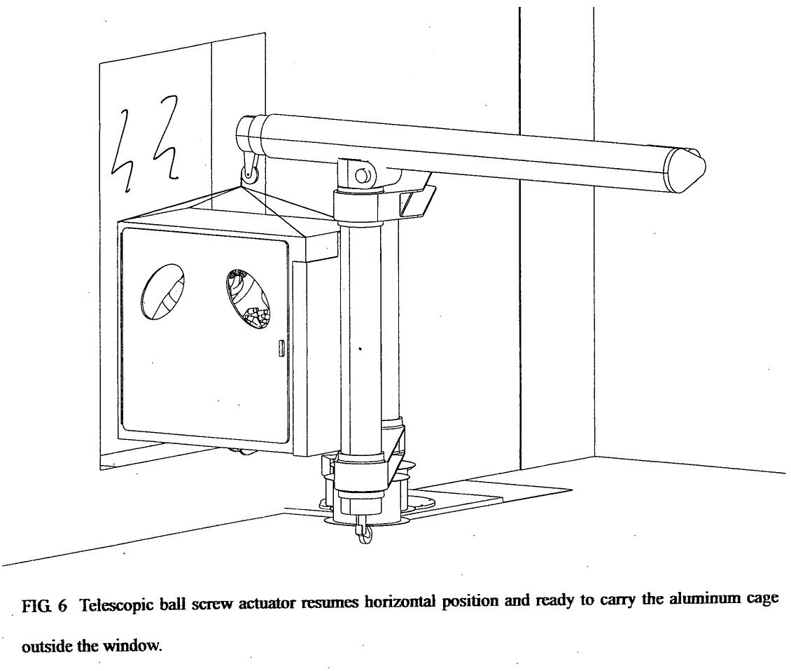

FIG. 7 Telescopic ball screw actuator extends the aluminum cage and escapees to outside the window.

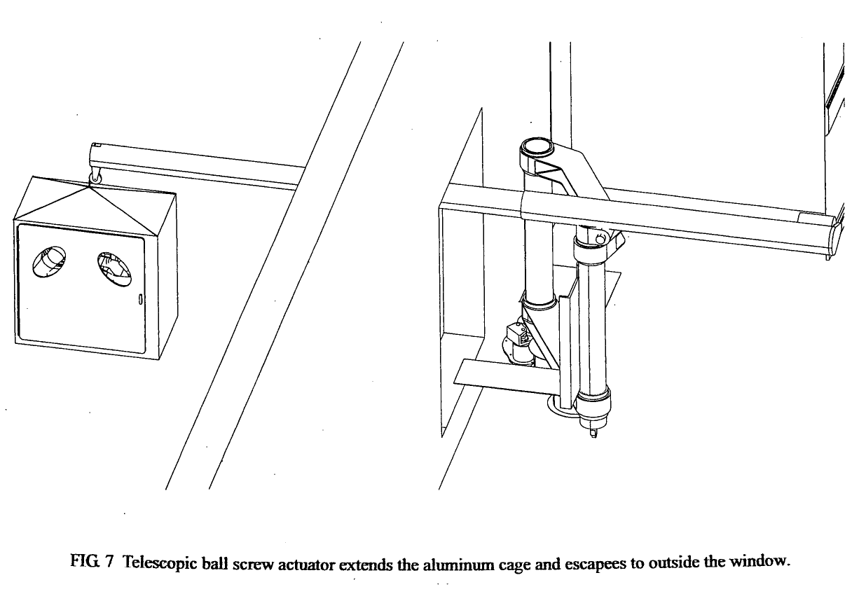

FIG. 8 The winch releases the wire and the aluminum cage and escapees descend to ground.

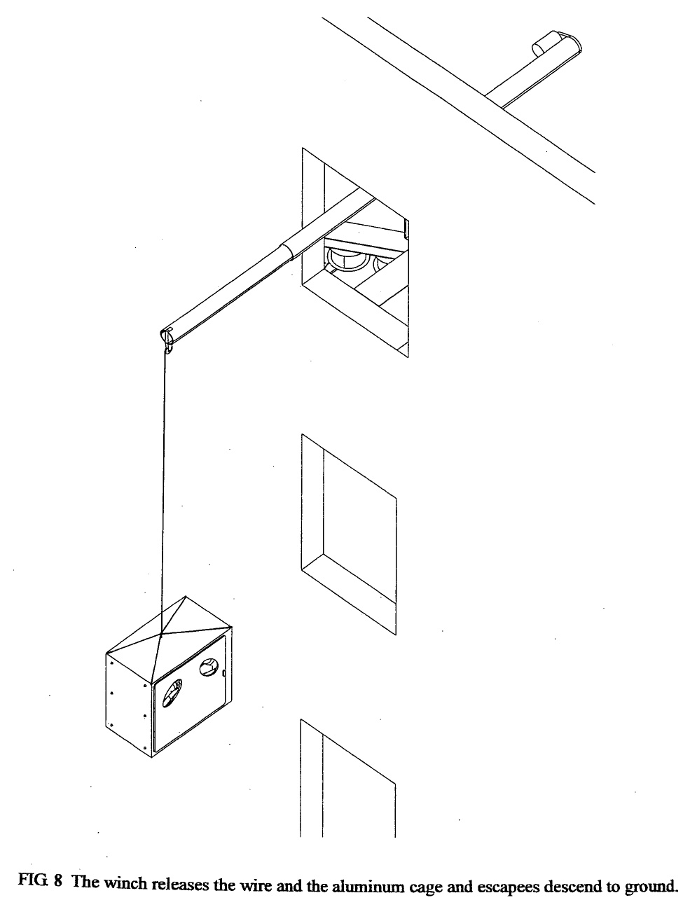

FIG. 9 Top view of moving aluminum cage.

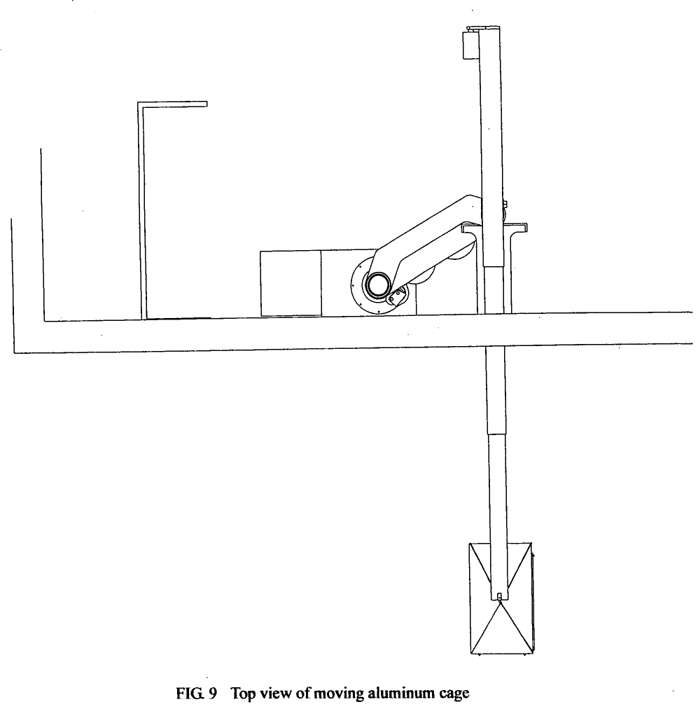

FIG. 10 The aluminum cage and escapees land on the ground.

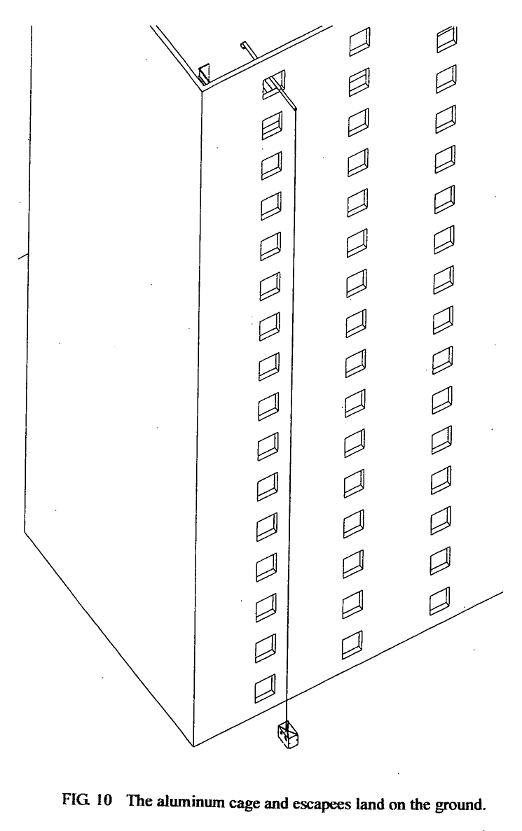

FIG. 11 Drawing shows the list of the escape system parts.

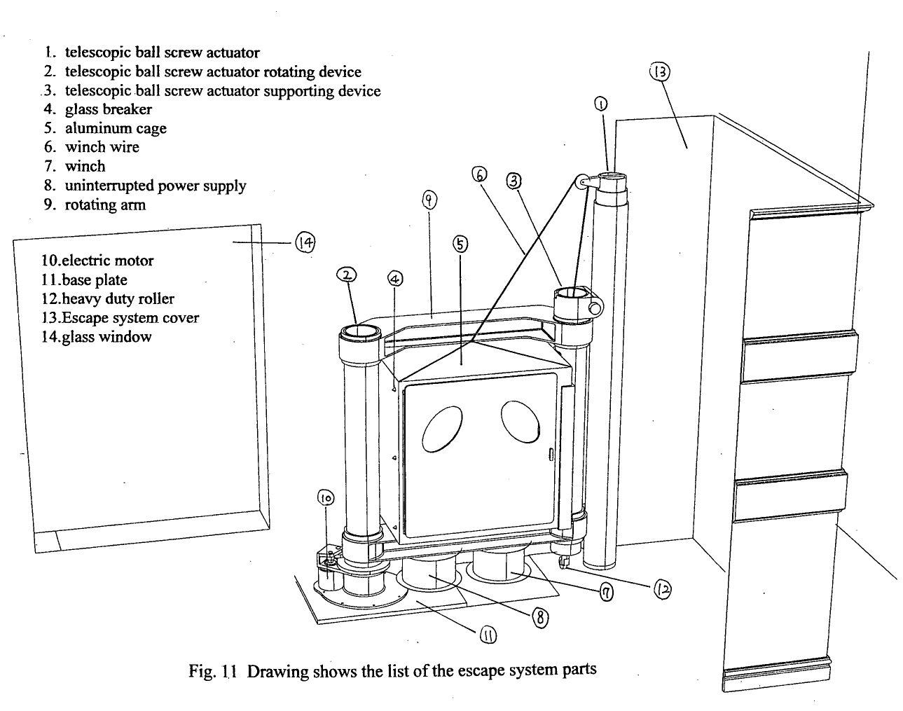

### DESCRIPTION OF THE PREFERRED EMBODIMENT

The present invention provides a last resort for high rise dwellers in the case of evacuation arising from fire or other emergencies. This system comprises of a telescopic ball screw actuator, electric motor for the telescopic ball screw actuator, telescopic ball screw actuator rotating device, telescopic ball screw actuator supporting device, electric motor for telescopic ball screw actuator rotating device, glass breaker, aluminum cage, variable speed winch, electric motor for winch, winch wire, 2 RVDTs for the winch sensor, an uninterrupted power supply, and base plate. The telescopic ball screw actuator works as a three stage actuator extending 2-3 m outside the window. The telescopic ball screw actuator can be extended quickly and can withstand a large bending momentum. The telescopic ball screw actuator is made of corrosion resistant high strength steel for durability and functionality. The telescopic ball screw actuator rotating device is a strong column with rotating arms. The rotating device is made of high strength steel to make the system compact. The telescopic ball screw actuator supporting device is attached to the two rotating arms. The lower side of the telescopic ball screw actuator supporting device is supported by a heavy duty roller to accommodate the load applied by the aluminum cage and escapees, thus it distributes the bending momentum when the system is in use. The aluminum cage is situated between two arms and supported by the supporting plate attached to the telescopic ball screw actuator supporting device. The glass breakers are attached to window side of the aluminum cage. The glass breakers resemble claws. A glass breaker consists of 6 claws and each claw consists of 2-3 drills. At the end of each claw, there is a very sharp drill to break the thick glass of high rise windows. The claw is made of tool steel and is approximately 2-5 cm long. These 6 claws are attached to the window side of the aluminum cage. Once the aluminum cage is pushed to the window side, the 6 claws break the glass to give the way for the escapees in the aluminum cage. The variable speed winch enables the aluminum cage to lower slowly in the beginning, then quickly for the majority of the descent, and then slowly again for the final ground landing. The winch wire is composed of bundled, galvanized steel wire. The bundles are jacketed with polymer material. To ensure a safe landing, the length of the winch wire is customized to each system depending upon the height of the building. The aluminum cage is structurally sturdy to accommodate the stress from breaking the glass. The aluminum cage will protect the escapees in cases of the aluminum cage hitting the building wall from unexpected swings and from the heat of potential fires. 2 RVDTs will reduce the winch rotating speed approximately 5-10 m above the ground to ensure a safe landing. One RVDT is the main functional sensor and the second is a backup for additional safety. 3 electric motors power the actuator, telescopic ball screw actuator rotating device, and winch. In case of an electrical black out, the uninterrupted power supply will power the 3 electric motors.

All of the parts are encased in closet size (approximately 2.0 m high, 1.2 m wide, and 1.0 m deep) furniture. The system is firmly attached to the base plate and the base plate is firmly anchored to the floor. This construct ensures that the system will withstand the bending momentum applied by the weight of escapees, aluminum cage hung at the end of the telescopic ball screw actuator, and dynamic load. An L-shaped bracket is attached to the wall side of the base plate to distribute the bending momentum to the wall side. The layout and detailed drawings are attached. The system operates in the following sequence:
1. Open the closet door
2. Press the 1^{st} button; the actuator swings out and the aluminum cage hangs to the end of the actuator
3. Escapees get into the aluminum cage
4. Press the 2^{nd} button; the telescopic ball screw actuator rotating device rotates a few degrees to push the aluminum cage toward the window. This enables the glass breaker on the window side of the aluminum cage to break the glass. The actuator starts to extend outside the window and the aluminum cage containing escapees is transported outside.
5. As the actuator completes the extension, press the 3^{rd} button. This allows the winch to activate and the aluminum cage begins to descend.
6. Escapees land on the ground.

What is claimed is:

1. Design and manufacturing of the high rise escape system which allows escaping of high rise dwellers from disabled elevators and blocked stairways caused by fire or other unexpected accidents in less than 1.5 minute, the system being comprised of cover furniture, a telescopic ball screw actuator, telescopic ball screw actuator supporting device, telescopic ball screw actuator rotating device, glass breaker, aluminum cage for escapees, variable speed winch, winch wire, rotary variable differential transformer (RVDT) position sensor, an uninterrupted power supply (UPS), and base plate.

2. The escape mechanism of claim 1 wherein telescopic ball screw actuator, telescopic ball screw actuator supporting device, glass breaker, and aluminum cage for escapees swing out from the furniture-like system.

3. The escape mechanism of claim 1 wherein said system includes the glass breaking function with glass breaker attached to the aluminum cage.

4. The escape mechanism of claim 1 wherein said system utilizes telescopic ball screw actuator to make said system compact.

5. The escape mechanism of claim 1 wherein said system utilizes aluminum cage to protect the escapees from heat and unexpected collision to the structure.

6. The escape mechanism of claim 1 wherein said system utilizes variable speed winch to make the descending fast and smooth.

7. The design of claim 1 wherein said system is operated from the beginning to the landing by three buttons, making said system extremely simple to operate.

8. The design of claim 1 wherein said system is supported by the base plate and wall side bracket to minimize upward bending momentum during descent.

9. The design of claim 1 wherein the telescopic ball screw actuator supporting device is supported by the roller during its operation to distribute the bending momentum.

10. The design of claim 1 wherein the uninterrupted power supply will power three electric motors in case of an electrical black out.

11. The design of claim 1 wherein the system is private and installed as furniture in office or residential room.
